(19) United States
(12) Patent Application Publication
(10) Pub. No.: US 2008/0202783 A1
(43) Pub. Date: Aug. 28, 2008

(54) Method for controlling a linear motor for driving a striking mechanism

(76) Inventors: Roland Schaer, Grabs (CH); Albert Binder, Buchs (CH); Juergen Muendle, Satteins (AT)

Correspondence Address: ABELMAN, FRAYNE & SCHWAB, 666 THIRD AVENUE, 10TH FLOOR, NEW YORK, NY, 10017, US

(21) Appl. No.: 12/069,851

(22) Filed: Feb. 12, 2008

(30) Foreign Application Priority Data
Feb. 13, 2007 (DE) 10 2007 000 085.7

(51) Int. Cl. B25D 11/06; B25D 13/00

(52) U.S. Cl. 173/117; 173/176; 173/118

(57) ABSTRACT

A method of controlling a single-phase linear motor (1) for driving a striking mechanism (2) with a loose coupling (4) between a runner (5) of the linear motor (1) and a striker (6) of the striking mechanism (2) has, within a striking period in which exactly one force impact (K) of the striker (6) is carried out on a tool (8) or an anvil (7), a pull phase (Z) in which the loose coupling (4) contacts a runner-side contact surface (KL) with a one-sided constrained contact and a push phase (D) in which the loose coupling (4) contacts a striker-side contact surface (KS) with a one-sided constrained contact, and a change phase (W) provided between the pull phase (Z) and the push phase (D) in which the one-sided constrained contact changes between the two contact surfaces (KL-KS) along a contactless reciprocating gap (S) in that the runner (5) releases the one-sided constrained contact with one contact surface (KL/KS) in a regulated manner and produces the one-sided constrained contact with the other contact surface (KS/KL), the method including the step of discretely triggered at least the change phase (W) from the pull phase (Z) to the push phase (D) by the local position of the runner (5) relative to the pole period (P) of salient poles of the linear motor (1).

### BACKGROUND OF THE INVENTION

1. Field of the Invention

The invention relates to a method for controlling a single-phase linear motor with salient poles for driving a striking mechanism with a loose coupling between the runner of the linear motor and the striker of the striking mechanism which is preferably part of an at least partially percussive hand-held electric power tool.

2. Description of the Prior Art

According to British Publication GB 1396812, the soft-magnetic runner in a linear motor, which is designed to drive a striking mechanism, is constructed directly as a striker which directly strikes the power tool-side end surface of the working tool or anvil.

U.S. Pat. No. 4,553,074 discloses an associated method for controlling the linear motor.

According to European Publication EP0718075, a permanently-magnetic runner of a linear motor without salient poles is connected to the striker by a loose coupling with exactly two contact sides between which a contactless gap is formed. Over the course of a driving cycle, the runner which is controlled by a control unit is moved exactly once against the striker by one of the two contact sides of the loose coupling, and the striker is accordingly captured in the one-sided constrained contact. The impact of the striker on the tool is carried out in the disengaged state of the runner so that the impact movement of the striker does not recoil on the runner.

According to International Publication WO 2006108524, the striker is connected by a loose coupling of the type mentioned above to the permanently-magnetic runner of a single-phase linear motor with salient poles, which is more powerful than a linear motor without salient poles. Owing to the fact that the force acting on the runner in a single-phase linear motor with salient poles is locally periodically depended on the pole separation and, further, that a locking force which securely holds the runner, is formed in the neutral positions of the runner, a conventional control unit of a linear motor without salient poles is unsuitable for the runner.

### SUMMARY OF THE INVENTION

The object of the invention is a method for controlling a linear motor with salient poles and which drives a striking mechanism which method prevents the runner from hanging on the salient poles.

A further object of the invention consists in capturing the striker that is connected by a loose coupling in a fatigue-reducing manner, i.e., without high stresses, in spite of the locally periodic force progression.

These and other objects of the present invention, which will become apparent hereinafter, are achieved by providing a method of controlling a single-phase linear motor for driving a striking mechanism having a loose coupling between a runner of the linear motor, which runner is driven in a regulated manner, and a striker of the striking mechanism, includes within a striking period in which exactly one force impact of the striker is carried out on a working tool or an anvil, a pull phase in which the loose coupling contacts a runner-side contact surface with a one-sided constrained contact, and a push phase in which the loose coupling contacts a striker-side contact surface with a one-sided constrained contact. Between the pull phase and the push phase, there is provided a change phase in which the one-sided constrained contact changes between the two contact surfaces along a contactless reciprocating gap. During the change phase, the runner releases the one-sided constrained contact with one contact surface in a regulated manner and produces the one-sided constrained contact with the other contact surface. At least the change phase from the pull phase to the push phase is discretely triggered by the local position of the runner relative to the pole period of salient poles of the linear motor.

The discrete triggering of the change phase by the local position of the runner relative to the pole period of the salient poles of the linear motor results in a most possible reproduction of starting conditions for the control loop even when this takes place with locally different periods of the runner in which a speed criterion is also met as an additional, secondary condition.

The one-sided constrained contact advantageously changes during the change phase during which the one-sided constrained contact of the loose coupling with one contact surface is released in a braking phase by braking of the runner, and the one-sided constrained contact of the loose coupling with the other contact surface is restored in a capture phase by a regulated approach of the runner. Thereby, the capture phase can also be discretely triggered with the local position of the runner relative to the pole period of salient poles of the linear motor.

The control loop, in use during the change phase, advantageously comprises a differential position control with a subordinated differential speed control. Both controls are advantageously designed as proportional-integral-differential (PID) controls, whereby overshooting, which leads to repeated contact shocks within the loose coupling and which impairs the permanent magnetization and durability of the runner, is prevented.

The capture phase advantageously takes place only after a speed difference between the striker and the runner falls below a speed difference limit as an additional, secondary condition, whereby a smooth contact is always effected and always lies well below the durability limit for compression threshold stresses of the loose coupling. Also in an advantageous manner, a regulated approach is switched to a controlled approach in the capture phase when a position difference between the striker and the runner falls below a position difference limit which serves as triggering condition. Thereby, a slow approach is prevented, and the two bodies come into contact substantially faster.

The change phase, which follows the pull phase, advantageously occurs only when a predetermined set energy is reached in the subsequent compression phase by the speed of the striker and runner (optionally while taking into account additional friction losses), whereby the impact power can be controlled.

The change phase, which follows the push phase, advantageously occurs precisely when a braking energy, which is necessitated by the runner speed and runner position and with which the runner (optionally while taking into account additional friction losses) can be braked before a working tool-side reversal point (which is optionally dependent on the position of the working tool or anvil) precisely for reversing the movement direction, reaches a limiting energy which is determined by the electrodynamically available driving energy. Thereby, the maximum impact power can be achieved.

With the positions and speeds of the striker and runner being determined by sensors, at least one storage array (addressable in multiple dimensions) with reference values, which are determined empirically or by means of a simulated model and which are advantageously interpolated in multiple dimensions, advantageously serves to determine the different kinetic energies and the available driving energy (braking energy) or the use positions of the change phases directly. Thereby, the necessary regulating steps can be carried out very quickly in order to achieve impact frequencies between 10 Hz and 100 Hz.

In an advantageous manner, a rest phase is available during the compression phase at the rear dead center of the movement of the runner and striker, whereby the impact frequency can be controlled over its duration.

The novel features of the present invention which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a position/time diagram of a hand-held power tool, illustrating a controlled movement sequence; and

FIG. 2 a cross-sectional view of another embodiment of a hand-held power tool.

### DETAILED DESCRIPTION OF THE PREFERRED EMBODIMENTS

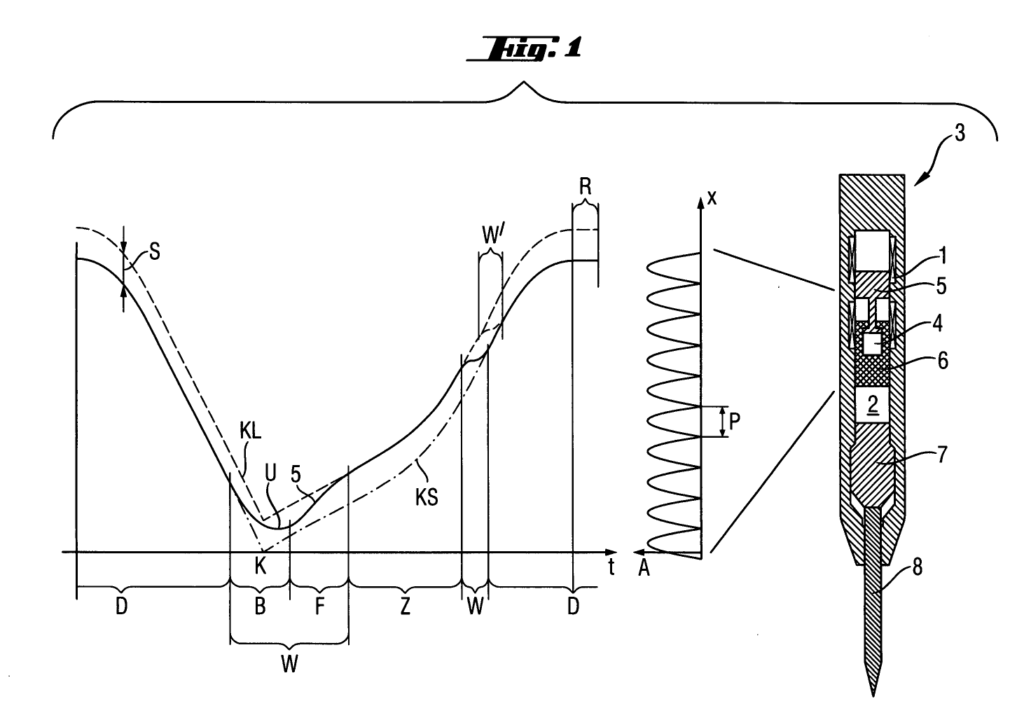

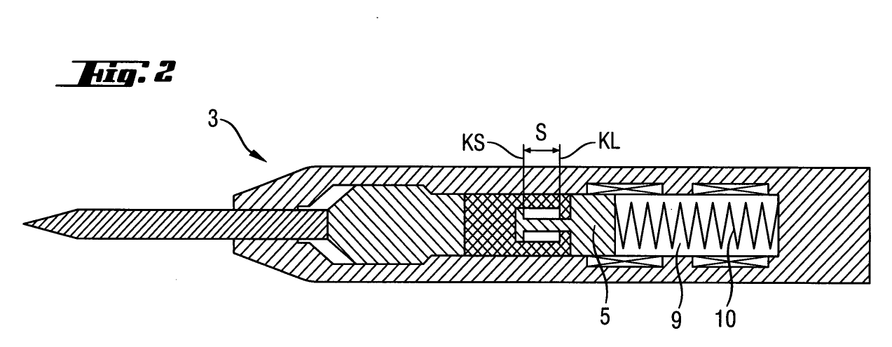

According to FIG. 1, a method of controlling the single-phase linear motor 1 for driving a striking mechanism 2 of a hand-held power tool 3 with a loose coupling 4 between a runner 5 of the linear motor 1, which runner 5 is driven in a regulated manner, and a striker 6 of the striking mechanism 2 brings about a regulated movement sequence of the runner 5 in which exactly one force impact K of the striker 6 is applied to a working tool 8 by the anvil 7 within a striking period. The striking period has a pull phase Z and a push phase D which alternate by a change phase W. In the pull phase Z, the loose coupling 4 contacts a runner-side contact surface KL (FIG. 2) with a one-sided constrained contact. In the push phase D, the loose coupling 4 contacts a striker-side contact surface KS (FIG. 2) with a one-sided constrained contact. In the change phase W, the one-sided constrained contact changes between the two contact surfaces KL-KS (FIG. 2) along a contactless reciprocating gap S (FIG. 2). Thereby the one-sided constrained contact with one contact surface is released in a braking phase B by an active braking of the runner 5, and the one-sided constrained contact to the other contact surface is restored in a capture phase F by a regulated approach of the runner 5 to the striker 6 which is freely movable apart from the friction. This change phase W is discretely triggered dependent on the local position of the runner 5 relative to the pole period P of salient poles (not shown) of the linear motor 1 so that, with respect to a change phase W being considered, a change phase W′ coming next locally is discretely displaced by exactly one pole period P which again has the same progression of driving force A of the linear motor 1. The control loop, in use in the method for the change phase W, comprises a differential position control between the runner 5 and the striker 6 with a subordinated differential speed control. Both controls are designed as proportional-integral-differential (PID) controls and are adapted in such a way that the rebounding between the runner 5 and striker 6 is minimized. The capture phase F during the change from the push phase D to the pull phase Z first takes place when, as an additional, secondary condition, the speed difference falls below a speed difference limit between the striker 6 and the runner 5 of 0.1 μm/s, that is, when they are practically identical. A controlled approach is switched to when a position difference value falls below a position difference limit between the striker 6 and the runner 5 of <0.2 mm. The change phase W, which follows the pull phase Z, occurs only when a predetermined set energy ES, which is controlled by the user, is reached by the common speed of the striker 6 and runner 5. The change phase W, which follows the push phase D, occurs precisely after a braking energy EB, which is necessitated by the runner speed and runner position and by which the runner 5 can be braked for reversing the movement direction before a working tool-side reversal point U, which depends on the position of the tool 8 and anvil 7, reaches a limiting energy EG 4 J that is determined by the maximum electrodynamically available driving energy. When the positions and speeds of the striker 6 and runner 5 are sensed by sensors, a storage array which is addressable in multiple dimensions with reference values, which are determined empirically or by means of a simulated model and which are interpolated in multiple dimensions, serves to determine the different kinetic energies ES, EB or the use positions of the change phases W directly. There is available a rest phase R during the push phase D at the rear dead center of the movement of the runner 5 and striker 6.

According to FIG. 2, the driving force A of the linear motor 3 is additionally reinforced by a pneumatic spring 9 and/or mechanical compression spring 10 arranged behind the runner 5. The force or energy of these springs is then taken into account in the calculation.

Though the present invention was shown and described with references to the preferred embodiments, such are merely illustrative of the present invention and are not to be construed as a limitation thereof, and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A method of controlling a single-phase linear motor (1) for driving a striking mechanism (2) that includes a loose coupling (4) arranged between a runner (5) of the linear motor (1), which runner (5) is driven in a regulated manner, and a striker (6) of the striking mechanism (2) which has, within a striking period in which exactly one force impact (K) of the striker (6) is applied to a working tool (8) or an anvil (7), a pull phase (Z) in which the loose coupling (4) contacts a runner-side contact surface (KL) with a one-sided constrained contact, a push phase (D) in which the loose coupling (4) contacts a striker-side contact surface (KS) with a one-sided constrained contact, a change phase (W) between the pull phase (Z) and the push phase (D) in which the one-sided constrained contact changes between the runner-side and striker-side contact surfaces (KL-KS) along a contactless reciprocating gap (S), with the runner (5) releasing the one-sided constrained contact with one contact surface (KL/KS) in a regulated manner and producing the one-sided constrained contact with another contact surface (KS/KL), the method comprising the step of discretely triggering at least the change phase (W) from the pull phase (Z) to the push phase (D) by the local position of the runner (5) relative to the pole period (P) of salient poles of the linear motor (1).

2. A method according to claim 1, comprising the step of changing the one-sided constrained contact in the change phase (W) by releasing the one-sided constrained contact of the loose coupling (4) to the one contact surface (KL/KS) in a braking phase (B) by braking the runner (5) and restoring the one-sided constrained contact of the loose coupling (4) to the other contact surface (KS/KL) in a capture phase (F) by a regulated approach of the runner (5).

3. A method according to claim 1, wherein a control loop in use during the change phase (W), comprises a differential position control with a subordinated differential speed control.

4. A method according to claim 1, wherein the capture phase (F) takes place only after a speed difference between the striker (6) and the runner (5) falls below a speed difference limit as additional secondary condition.

5. A method according to claim 1, wherein the change phase (W) which follows the pull phase (Z), occurs only when a predetermined set energy (ES) is reached in a subsequent push phase by the speed of the striker (6) and runner (5).

6. A method according to claim 1, wherein the change phase (W), which follows the push phase (D), occurs precisely when a braking energy (EB), which is necessitated by the runner speed and runner position and by which the runner (5) can be braked before a working tool-side reversal point (U) precisely for reversing movement direction, reaches a limiting energy (EG) which is given by the electrodynamically available driving energy.

7. A method according to claim 1, wherein upon the positions and speeds of the striker (6) and the runner (5) being sensed by sensors, at least one storage array with reference values which are determined empirically or by means of a simulated model, serves to determine different kinetic energies (ES) and available driving energy or braking energy (EB) or use positions of the change phases (W) directly.

8. A method according to claim 1, comprising the step of providing a rest phase (R) during the push phase (D) at a rear dead center of movement of the runner (5) and the striker (6).
